(19) United States
(12) Patent Application Publication
(10) Pub. No.: US 2025/0179996 A1
(43) Pub. Date: Jun. 5, 2025

(54) TOWER BASE AUTOMATIC VENTILATION SYSTEM FOR THERMAL CONVECTIVE WIND POWER GENERATION DEVICE

(71) Applicant: CHIO-SUNG CHANG, Pingtung County (TW)

(72) Inventor: CHIO-SUNG CHANG, Pingtung County (TW)

(21) Appl. No.: 18/407,450

(22) Filed: Jan. 9, 2024

(30) Foreign Application Priority Data
Nov. 30, 2023 (TW) 112146545

(51) Int. Cl. F03D 80/60; H02K 5/20; H02K 7/18; H02K 9/06

(52) U.S. Cl. CPC F03D 80/60; H02K 5/207; H02K 7/183; H02K 9/06; F05B 2260/232; H02K 2205/09

(57) ABSTRACT

A tower base automatic ventilation system for thermal convective wind power generation device, comprising: an duct body, which is a bottom-up extended molding structure for blowing hot air from the lower end of the duct body to the upper end of the duct body to form wind power; and a power generator, which is located in the holding chamber, and the power generator includes a driving shaft, rotating fan blades, and a power generation unit, and the rotating fan blades are rotatable by the driving shaft in the holding chamber, and the rotary fan blade is configured to start generating electricity by rotating at a high speed by the high efficiency blade group driven by the wind beam flowing from the bottom of the duct body to the top of the duct body due to the convection current and rapidly drive the power generation unit and continuously generate electricity.

### TECHNICAL FIELD

The present invention relates to a tower base automatic ventilation system for thermal convective wind power generation device, and in particular, a tower thermal convection wind turbine which compresses and enhances wind speed by means of a Venturi structure without carbon emissions.

### PRIOR ART

With the gradual depletion of natural resources such as oil, coal and carbon, coupled with the abnormal changes in global climate and the international attention to environmental protection issues, the current thermal power generation in the future due to environmental protection and lack of resources, and can no longer continue to generate electricity, in view of this, how to develop clean and zero-pollution renewable energy for sustainable use, that is, a very important issue, which, again, the wind power generation Among them, wind power is the most widely used.

The commonly known wind power generation device relies on natural wind power to drive the fan blades, which rotate to generate power for the generator, which can convert wind energy into electricity for convenient storage or transportation of energy to meet the energy needs of life. However, the strength of the natural wind is unstable and uncontrollable. When the heat and wind force decreases to a point where it is not strong enough to push the fan blades, the generator stops outputting electricity; and when the wind force increases to a point where it exceeds the structural strength of the fan blades or the load of the generator, it may result in a reduction in the life span of the fan blades or overheating of the circuit of the generator, which may lead to damage.

### CONTENTS OF THE INVENTION

The present invention provides a tower base automatic ventilation system for thermal convective wind power generation device, the purpose of which is to enhance the wind speed and volume through a Venturi structure, and to combine a high-efficiency and a magnetic generator power generation device.

A tower base automatic ventilation system for thermal convective wind power generation device of the present invention comprises: a duct body, which is a bottom-to-top extended molding structure for blowing an air from a lower end of the duct body to an upper end of the duct body to form a wind force, and the duct body has a first wide-diameter portion, a second wide-diameter portion, and a narrow-diameter portion connected to each other, the first wide-diameter portion is connected to an air intake chamber, and the second wide-diameter portion is connected to a holding chamber, and the second wide-diameter portion is connected to the first wide-diameter portion and the second wide-diameter portion; and a power generator disposed in the holding chamber, the power generator comprising a driving shaft, a rotary fan blade, and a power generation unit, the rotary fan blade being disposed in the holding chamber in a rotatable manner by means of the driving shaft, the rotary fan blade being disposed in a position to be subjected to wind force flowing from a bottom portion of the duct body towards a top portion of the duct body.

This device is installed in the building to expand the pipeline between the thermal convection effect can make the building to play the indoor and outdoor air convection at the same time, and then drive the generator to generate electricity to supply the whole building power needs, so that the whole building can be detached from the main power grid (Off Grids) to become a 100% carbon-emission-free, but also can be active breathing, ventilating the intelligent green building.

In one embodiment of the present invention, the above mentioned duct body includes a first tapered portion where the first wide-diameter portion gradually becomes thinner towards the narrow diameter portion, and a second tapered portion where the narrow diameter portion gradually becomes wider towards the second wide-diameter portion, and the angle formed by the first tapered portion and the center axis of the duct body is greater than or equal to the angle formed by the second tapered portion and the center axis of the duct body.

In one embodiment of the present invention, the duct body is a Venturi channel, and when the air flows through, the air flow speed rate increasing and the pressure decreasing due to the reduced cross-portion of the narrow-diameter portion, so as to create the wind force and speed.

In one embodiment of the present invention, the lower end of the above-described duct body further comprises at least one air intake for allowing the air to enter the air intake chamber of the duct body.

In one embodiment of the present invention, the duct body as described above creates a chimney effect that causes the air to form a flow of air from the air intakes into the duct body.

In one embodiment of the present invention, the upper end of the duct body as described above further comprises an air outlet for discharging the air force out of the duct body.

In one embodiment of the present invention, the above-described power generator is provided with a vertical driving shaft, which is perpendicular to the ground surface on which the duct body is located.

In one embodiment of the present invention, the power generator described above is provided with a power generation unit and a horizontal rotating fan blade, which are perpendicular to the wind power.

In one embodiment of the present invention, the above-described power generator further comprises a power generation unit fixing bracket for fixing the power generation unit in the holding chamber.

In one embodiment of the present invention, the above-described power generation unit comprises a kinetic energy input end and a power generation output end, wherein the kinetic energy input end is connected to the driving shaft and driven by the driving shaft, and wherein the power generation unit is configured to convert kinetic energy from the kinetic energy input end into electrical energy and output from the power generation output end.

The effect of the present invention is that, through the ground air near the bottom of the tower thermal convection wind power generator of the present invention, due to the effect of the internal chimney structure of the wind power generator, the air is naturally induced to be sucked into the internal pipeline of the wind power generator, and the air sucked into the internal pipeline is accelerated due to the effect of the convection of the chimney, coupled with the principle of the Venturi tube, so that the air is concentrated in the internal pipeline of the wind power generator, forming a concentrated, fast, strong and powerful wind beam, which can directly drive the rotating fan blades of the generating set to the top of the wind power generator, and can directly drive the rotating fan blades of the power generator to rapidly drive the power generation unit and continuously generate electricity all the time.

### BRIEF DESCRIPTION OF THE DRAWINGS

FIG. 1 is a schematic diagram of a tower base thermal convection wind power generation device according to the present invention.

FIG. 2 is a schematic diagram of an embodiment of a tower base thermal convection wind power generation device according to the present invention.

FIG. 3 is a schematic diagram of a power generator of a tower-base thermal convection wind power generation device according to the present invention.

### DETAILED DESCRIPTION OF THE EMBODIMENTS

In order to make the above features and advantages of the present invention more obvious and easy to understand, hereinafter the following embodiments are cited, together with the accompanying drawings, in addition to these detailed descriptions, the present invention may also be broadly implemented in other embodiments, and any of the said embodiments of the easy substitution, modification, and equivalent changes are included in the scope of the present invention, and the scope of the application for a patent shall prevail. In the description of the specification, many specific details are provided in order to provide the reader with a more complete understanding of the invention; however, the invention may be practicable with some or all of the specific details omitted. In addition, well-known steps or components are not described in detail to avoid unnecessarily limiting the invention. Identical or similar elements in the drawings will be indicated by identical or similar symbols. It should be noted that the drawings are for illustrative purposes only, and do not represent the actual size or number of components, and some details may not be fully depicted for the sake of simplicity of the drawings, which are described in detail below.

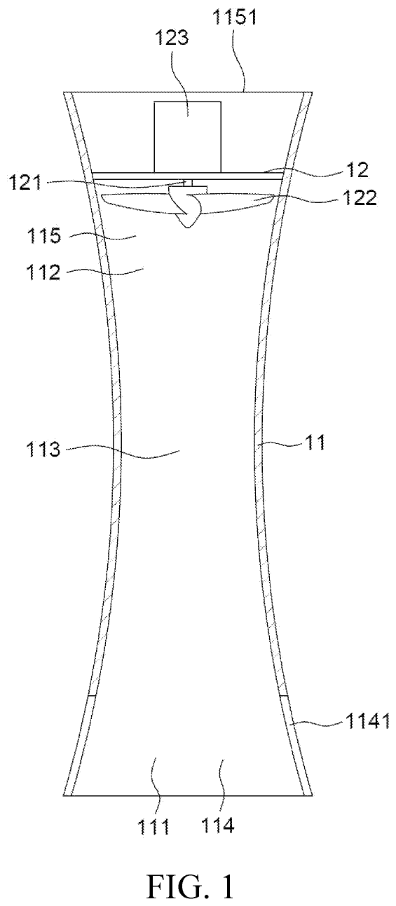

Referring to FIG. 1, FIG. 1 is a schematic diagram of a tower base automatic ventilation system for thermal convective wind power generation device according to one of the present inventions. One type of tower thermal convection wind power generation device of the present invention comprises: a duct body 11, which is a bottom-to-top extended molding structure for blowing an air from a lower end of the duct body 11 to an upper end of the duct body 11 to form a wind force, and the duct body 11 has a first wide-diameter portion 111, a second wide-diameter portion 112, and a narrow-diameter portion 113 connected to each other, the first wide-diameter portion 111 is connected to an air intake chamber 114, and the second wide-diameter portion 112 is connected to the holding chamber 115, and the narrow-diameter portion 113 interfaces with the first wide-diameter portion 111 and the second wide-diameter portion 112; and a power generator 12 is disposed in the holding chamber 115, the power generator 12 comprising a driving shaft 121, a rotary fan blade 122, and a power generation unit 123, The rotary fan blade 122 is disposed in the holding chamber 115 in a rotatable manner by means of the driving shaft 121, and the rotary fan blade 122 is configured to rotate when pushed by the wind force flowing from the bottom of the duct body 11 toward the top of the duct body 11, to drive the driving shaft 121 to rotate and generate electricity by means of the power generation unit 123.
wherein the power generator 12 may be, but is not limited to, a highly efficient and magnetic generating unit.

In this embodiment, the duct body 11 comprises a first tapered portion of the first wide-diameter portion 111 tapering toward the narrow-diameter portion 113, and a second tapered portion of the narrow-diameter portion 113 tapering toward the second wide-diameter portion 112, and the angle formed by the first tapered portion with the center axis of the duct body 11 is greater than or equal to the angle formed by the second tapered portion with the center axis of the duct body 11.
wherein the first wide-diameter portion 111 is a flared wide diameter portion.
wherein the second wide-diameter portion 112 is a flared wide diameter portion.

In this embodiment, the duct body 11 is a Venturi channel, and when the air flows through, due to the reduced cross-portion of the narrow-diameter portion 113, the air flow rate increasing and the pressure decreasing to create the wind force.

In this embodiment, the lower end of the duct body 11 further comprises at least one air intake 1141 for allowing the air to enter the air intake chamber 114 of the duct body 11.

In this embodiment, the duct body 11 creates a chimney effect to cause the air to form a flow of air from the air intakes 1141 into the duct body 11.

Wherein, because the internal temperature of the air intake chamber 114 in the duct body 11 is higher than the natural temperature outside the duct body 11, the external air convection to the air intake chamber 114, forming a thermal convection.

In this embodiment, the upper end of the duct body 11 includes an air outlet 1151 for discharging the air from the duct body 11.

In this embodiment, the power generator 12 is provided with a vertical driving shaft 121, which is perpendicular to the ground on which the duct body 11 is located.

In this embodiment, the power generator 12 is provided with a power generation unit 123 and a horizontal rotating fan blade, perpendicular to the wind.

Wherein the rotary fan blade 122 is a high-efficiency fan blade.

In this embodiment, the power generator 12 further includes a power generation unit fixing bracket for fixing the power generation unit 123 in the holding chamber 115.

In this embodiment, the power generation unit 123 has a kinetic energy input end and a power generation output end, the kinetic energy input end is connected to the driving shaft 121 and driven by the driving shaft 121, and the power generation unit 123 is configured to convert kinetic energy from the kinetic energy input end into electrical energy and output from the power generation output end.

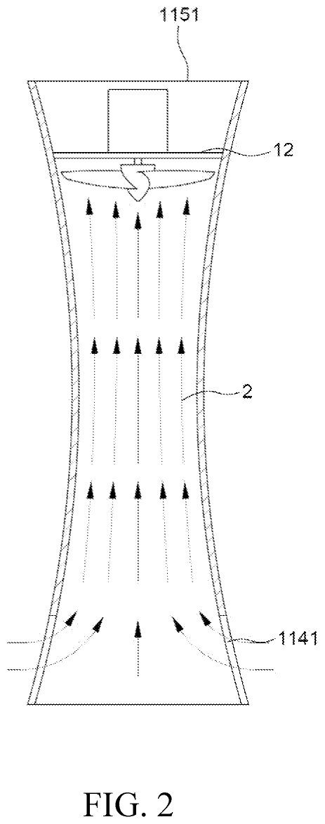

Referring to FIG. 2, FIG. 2 is a schematic illustration of an embodiment of a tower mounted thermal convection wind turbine according to one of the present inventions.

In FIG. 2, the ground air near the bottom of the tower thermal convection wind turbine of the present invention is naturally induced to be sucked into the internal piping of the wind turbine due to the effect of the internal chimney structure of the wind turbine, and the air sucked into the internal piping is accelerated due to the effect of the convection of the chimney and the principle of the Venturi tube, so that the air is concentrated in the internal piping of the wind turbine, forming a concentrated and rapid air flow. The internal piping of the wind power generator forms a concentrated, fast and powerful wind beam 2, which is accelerated to the top of the wind power generator, and can directly drive the rotary fan blades 122 of the power generator 12 to rapidly drive the power generator 12 to generate electricity continuously.

In this embodiment, the duct body 11 comprises a first tapered portion in which the first wide-diameter portion 111 becomes progressively thinner towards the narrow-diameter portion 113, and a second tapered portion in which the narrow-diameter portion 113 becomes progressively wider towards the second wide-diameter portion 112, and the angle formed by the first tapered portion and the center axis of the duct body 11 is larger or equal to the angle formed by the second tapered portion and the center axis of the duct body 11.

In this embodiment, the duct body 11 is a Venturi channel, and when the air flows through, the air flow rate increasing and the pressure decreasing due to the reduced cross-portion of the narrow-diameter portion 113, so as to create the wind force.

In this embodiment, the lower end of the duct body 11 further comprises at least one air intake 1141 for allowing the air to enter the air intake chamber 114 of the duct body 11.

In this embodiment, the duct body 11 creates a chimney effect that causes the air to form a flow of air from the air intakes 1141 into the duct body 11.

In this embodiment, the upper end of the duct body 11 further comprises an air outlet 1151 for discharging the wind out of the duct body 11.

In this embodiment, the power generator 12 is provided with a vertical driving shaft 121, which is perpendicular to the ground on which the duct body 11 is located.

In this embodiment, the power generator 12 is provided with a power generation unit 123 and a horizontal rotating fan blade, which are perpendicular to the wind.

In this embodiment, the power generator 12 further includes a power generation unit fixing bracket for fixing the power generation unit 123 in the holding chamber 115.

In this embodiment, the power generation unit 123 has a kinetic energy input end and a power generation output end, the kinetic energy input end is connected to the driving shaft 121 and driven by the driving shaft 121, and the power generation unit 123 is configured to convert kinetic energy from the kinetic energy input end into electrical energy and output from the power generation output end.

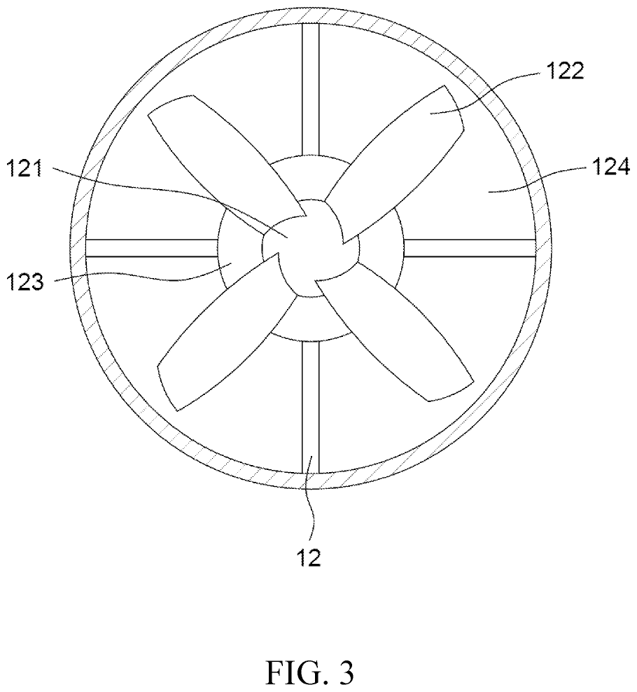

Referring to FIG. 3, FIG. 3 is a schematic diagram of a power generation unit of a tower base thermal convection wind power generation device according to one of the present inventions.

In FIG. 3, the power generator 12 is disposed in the holding chamber 115, the power generator 12 includes a driving shaft 121, a rotary fan blade 122, and a power generation unit 123, the rotary fan blade 122 is disposed in the holding chamber 115 in a rotatable manner by the driving shaft 121, and the rotary fan blade 122 is configured to rotate when pushed by wind force flowing from a bottom portion of the duct body 11 toward a top portion of the duct body 11, driving the driving shaft 121 to rotate and generate electricity through the power generation unit 123.

In this embodiment, the power generator 12 is provided as a vertical driving shaft 121, which is perpendicular to the ground on which the duct body 11 is provided.

In this embodiment, the power generator 12 is provided with a power generation unit 123 and a horizontal rotating fan blade, which are perpendicular to the wind.

In this embodiment, the power generator 12 further comprises a power generation unit fixing bracket 124 for fixing the power generation unit 123 in the holding chamber 115.

In this embodiment, the power generation unit 123 has a kinetic energy input end and a power generation output end, the kinetic energy input end is connected to the driving shaft 121 and driven by the driving shaft 121, and the power generation unit 123 is configured to convert kinetic energy from the kinetic energy input end into electrical energy and output from the power generation output end.

In summary, the effect of the present invention lies in the use of the Venturi channel structure in the duct body, so that the ground air enters the duct body, according to the effect of the Venturi principle that the air will produce acceleration inside the tube body, coupled with the principle that the higher the height of the tube body, the lower the pressure of the high altitude air, in order to stimulate the air inside the tube body to produce the wind power, and through the kinetic energy produced by the wind acceleration, will drive the power generation unit to produce the wind power. The rotating fan blade of the power generation unit will be driven, and the energy from the rotating fan blade will be used to drive the power generator to achieve the purpose of wind power generation, which has the advantages of better stability, low noise, and low production cost.

Although the present invention is disclosed as above by the aforementioned embodiment, it is not intended to limit the present invention, and any person skilled in similar arts and crafts, without departing from the spirit and scope of the present invention, may make changes and embellishments of equivalent substitutions, which are still within the scope of the patent protection of the present invention.

1: A tower-based ventilation system for thermal convective wind power generation, comprising:
a vertically extending duct body, configured to convey air from a lower end of the duct body to an upper end of the duct body;
said duct body comprising a first portion, a second portion, and a narrow portion, the first portion comprising an air intake chamber, the second portion comprising an air outlet chamber, the narrow portion connecting the first portion and the second portion; and
a power generator disposed in the air outlet chamber and comprising a shaft operatively coupled to a turbine, wherein the conveyed air drives the turbine to rotate and the turbine drives the generator to produce electrical power,
wherein the first portion, the narrow portion, and the second portion of the duct body jointly form a Venturi channel, the first portion defining an air intake opening in the lower end of the duct body, the second portion defining an air outlet opening in the upper end of the duct body, the narrow portion defining a reduced cross-section of the Venturi channel between the air intake opening and air outlet opening, wherein a flow rate of the conveyed air increases from the lower end of the duct body toward a reduced cross-section of the narrow portion and a pressure of the conveyed air decreases from the lower end of the duct body toward the reduced cross-section of the narrow portion, and wherein the conveyed air moves linearly in a moving direction along the duct body from the lower end to the upper end to pass through the Venturi channel.

2: The system according to claim 1, wherein a diameter of the first portion tapers from an inlet of the air intake chamber toward the narrow portion, and a diameter of the second portion tapers from an outlet of the air outlet chamber toward the narrow portion, wherein an amount of tapering of the first portion is greater than or equal to an amount of tapering of the second portion.

3-6. (canceled)

7: The system according to claim 1, wherein the duct body is arranged on and vertically extends from a ground surface and the shaft of the power generator is perpendicular to the ground surface.

8. (canceled)

9: The system according to claim 1, wherein the power generator comprises a fixing bracket for fixing the power generator in the air outlet chamber.

10. (canceled)
